(19) United States
(12) Patent Application Publication
(10) Pub. No.: US 2008/0092779 A1
(43) Pub. Date: Apr. 24, 2008

(54) Ultraviolet absorber formulation and method of preparing the same

(75) Inventors: Hui Tung Wang, Taipei City (TW); Ching-Chih Lai, Hsinchu (TW); Dean E Lin, Hsinchu County (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/723,119

(22) Filed: Mar. 16, 2007

(30) Foreign Application Priority Data
Oct. 19, 2006 (TW) 95138516

(51) Int. Cl. C04B 14/00; B05D 7/00

(52) U.S. Cl. 106/425; 427/216

(57) ABSTRACT

An ultraviolet absorber formulation and a method of preparing the same. The ultraviolet absorber formulation comprises a zinc oxide powder and a transparent coating on surfaces of the zinc oxide powder, thus forming a core-shell structure. The ultraviolet absorber is prepared by wet chemical surface modification. A zinc oxide powder is dispersed by media or non-media milling to provide a slurry of zinc oxide. The zinc oxide slurry is subjected to a coating process to deposit a transparent coating, thus giving the ultraviolet absorber.

### BACKGROUND OF THE INVENTION

1. Field of the Invention

The invention relates to ultraviolet absorber formulation and a method of preparing the same using wet chemical surface modification.

2. Description of the Related Art

Ultraviolet (UV) light is high-energy radiation that can cause cell damage and break some chemical bonds, thus being destructive to biological organisms and many organic substances. Various UV absorbers have been developed to reduce the deleterious effects of UV light radiation and achieve adequate conservation of material properties. For example, UV absorber is added to paint to prevent color fading or yellowing due to decomposition thereof. UV absorbers are also commonly used in cosmetics to protect skin from UV damage.

Most commercial UV absorbers are organic materials, manufacture of which involves use of organic solvents and is therefore not environmentally friendly. Accordingly, inorganic UV absorbers have been proposed to reduce potential harm to the environment. Inorganic particles provide effective UV protection by absorbing and scattering UV light. One important advantage of inorganic UV absorbers is high stability under UV radiation, which therefore, provides long term protection.

Titanium dioxide (TiO₂) is the most widely used inorganic UV absorber; however, it cannot provide effective protection over the entire UV spectra due to poor absorption at UV-A region (315-400 nm). In addition, TiO₂ incurs costs much higher than conventional UV absorbers.

U.S. Pat. No. 4,923,518 discloses a chemically inert pigmentary zinc oxide composition, useful in producing UV light stable polymeric resin. The composition is prepared by wet treatment of chemically reactive zinc oxide base pigments wherein chemically inert organic or inorganic coatings are deposited thereon. In the coating process, the pH of zinc oxide slurry is adjusted to 9.0 by NaOH before addition of sulfuric acid.

China Patent No. 1,407,029 discloses a method for preparing nano-sized composite particles, wherein silicon oxide is deposited on titanium oxide particle to provide a highly transparent, UV protection system. As described earlier, one problem with this system is the high cost of titanium oxide and its poor adsorption at UV-A region.

Thus, it would be highly desirable to provide a UV absorber that is less costly than titanium oxide and can be prepared by environmentally friendly processes, while still capable of providing good protection over the entire UV spectrum.

### BRIEF SUMMARY OF THE INVENTION

The invention provides an ultraviolet absorber formulation, comprising a zinc oxide powder and a transparent coating on surfaces of the zinc oxide (ZnO) powder, thereby forming a core-shell structure.

The invention also provides a method of preparing an ultraviolet absorber by wet chemical surface medication. The method comprises providing a zinc oxide powder, dispersing the zinc oxide powder by media or non-media milling to provide a zinc oxide slurry, and subjecting the zinc oxide slurry to a coating process to deposit a transparent coating on surfaces of the zinc oxide powder, thereby forming an ultraviolet absorber with a core-shell structure.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flowchart showing the preparation of UV absorber by wet chemical surface modification;

FIG. 2 is a TEM picture of the modified zinc oxide;

FIG. 3 is a diagram showing photocatalytic analysis of the modified zinc oxide; and

FIG. 4 is a diagram showing UV transmission curves of the modified and non-modified zinc oxide.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The UV absorber formulation of the invention comprises a core-shell UV absorber consisting of a zinc oxide core and a transparent coating as shell. A preferred constituent of the transparent coating is silicon oxide. It is preferable that the transparent coating constitute 10-40% by weight, more preferably 20-30% by weight of the core-shell structure. Generally, the transparent coating has a thickness of 5-100 nm, and the zinc oxide powder has a diameter of 10 nm-5 μm. In preferred embodiments of the invention, the transparent coating can reduce at least about 70-80% of the photocatalytic activity of the zinc oxide powder.

The UV absorber formulation may optionally include a hindered amine, particularly an organic hindered amine. Examples of suitable hindered amines include, but are not limited to, bis(N-methyl-2,2,6,6-tetramethyl-4-piperidyl)sebacate, methyl-(N-methyl-2,2,6,6-tetramethyl-4-piperidyl)sebacate, bis(2,2,6,6-tetramethyl-4-piperidyl)sebacate, and bis(1,2,2,6,6-pentamethyl-4-piperidyl)sebacate, wherein bis(1,2,2,6,6-pentamethyl-4-piperidyl)sebacate is particularly preferred. The weight ratio of the hindered amine to the zinc oxide powder is preferably controlled to about 2.5-1:1. The incorporation of the hindered amine provides a resin, e.g., PU, with improved resistance to yellowing and brittle fracture.

The UV absorber of the invention is characterized by good adsorption efficiency over a wide UV wavelength range from 230 to 400 nm. Typically, the UV absorber of the invention has an ultraviolet transmittance of less than 55% in wavelengths of 315-400 nm (UV-A region), and an ultraviolet transmittance of less than 35% in wavelengths of 280-315 nm (UV-B region) and 230-280 nm (UV-C region). Compared to the conventional TiO₂ absorber, the UV absorber of the invention has a higher UV-A absorption efficiency. Moreover, ZnO (3 USD/kg) costs much less than TiO₂ (15 USD/kg), thus providing economical advantages.

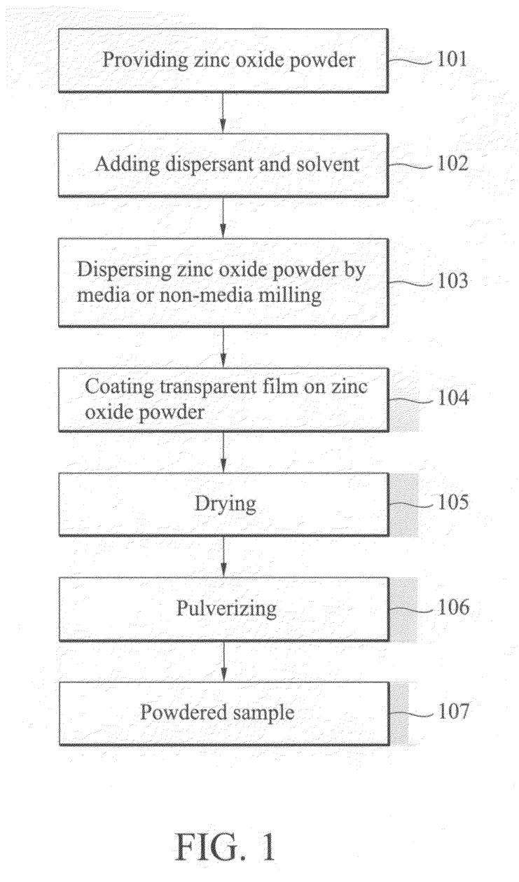

To achieve a high level UV adsorption while keeping the transparency of UV absorber, the zinc oxide powder is surface modified by a wet chemical method. An exemplary wet chemical method follows, with reference to the flowchart of FIG. 1. First, a zinc oxide powder (about 20-25 g) is provided (Step 101) and mixed with a solvent (about 200-300 g) and a dispersant (about 2-2.5 g) (Step 102). A dispersion process is performed using media or non-media milling to thoroughly disperse the zinc oxide powder to form a slurry (Step 103). A dispersion process performed by a non-media homogenizer is particularly preferred. The dispersant used in Step 102 may be any of a variety of dispersants, including cationic dispersant, anionic dispersant, amphoteric dispersant, or polymer dispersant. Water is preferably chosen as the solvent in Step 102 to reduce environmental impact. The weight ratio of zinc oxide to dispersant is preferably about 10:1, and that of zinc oxide to solvent is preferably 1:8 to 1:10. The zinc oxide slurry obtained in Step 103 was subjected to a coating process. The coating process typically comprises adding a coating precursor to the zinc oxide slurry, adjusting a pH of the zinc oxide slurry, and heating the zinc oxide slurry to deposit a transparent coating. When the transparent coating is silicon oxide, the precursor may be sodium silicate or other suitable silicon oxide precursors. After thoroughly mixing the precursor and the slurry, an acidic agent is added to adjust the pH of the slurry to above 7, preferably about 8-9. Examples of the acidic agent include sulfuric acid, hydrochloric acid, acetic acid, and phosphoric acid. In some embodiments, the pH of the slurry is maintained at about 8.5 or lower during the coating process without addition of an alkaline agent. Next, the slurry is heated to initiate the coating process. For example, the slurry can be heated by a water bath to about 85-100° C., preferably about 90-95° C. for 120-240 minutes. The slurry is agitated at a speed of 800-1000 rpm during this process. The coating process deposits a transparent coating on surfaces of the zinc oxide, thus giving a core-shell structure. Thereafter, the slurry containing modified zinc oxide is dried (Step 105) and pulverized (Step 106) to give a powdered sample (Step 107). Alternatively, the slurry can be spray dried. The slurry can be dried at 100-110° C., preferably at 105° C. for 20-24 hours, and pulverized for 5-7 minutes, preferably 5 minutes into fine particles by a pulverizer apparatus. The UV absorber thus obtained has an ultraviolet transmittance of less than 55% across the entire UV region from 230 nm to 400 nm. Moreover, the ultraviolet transmittance is less than 35% in wavelengths of 280-315 nm (UV-B region) and 230-280 nm (UV-C region).

The UV absorber of the invention may be used in polyurethane (PU), polyethylene (PE), acrylonitrile-butadiene-styrene (ABS), or paint to prevent or reduce color fading or yellowing. Additionally, the UV absorber may be used in cosmetics to provide protection to human skin. When the UV absorber is added to a paint solution, suitable dispersants include, but are not limited to, fish oil such as menhaden oil, cationic dispersant, anionic dispersant, amphoteric dispersant, or polymer dispersant. The paint solution can be coated and dried into a film by a variety of methods well known in the art.

Without intending to limit it in any manner, the invention is further illustrated by the following examples.

### EXAMPLE

Wet Chemical Surface Modification

20 g of zinc oxide powder was mixed with dispersant and 200 g of water. The resulting mixture was milled by a homogenizer to give a slurry containing well dispersed zinc oxide. 600 g of heated water (90-100° C.) and 2 g of sodium silicate were added to the slurry, and an acidic agent was added to adjust the pH to above 7.0. Next, the slurry was heated to 85-100° C. by a water bath and agitated at a speed of 800-1000 rpm for 120-240 minutes to deposit silicon oxide. After this, the slurry was cooled to room temperature, filtered, dried at 105° C. for one day, and pulverized for 5 minutes to give zinc oxide-silicon oxide core-shell composite particles.

Wet Chemical Surface Modification

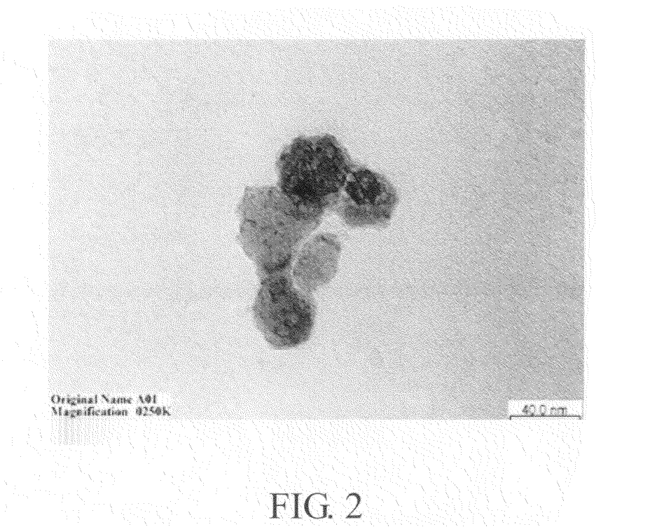

The primary particle size of original (non-modified) zinc oxide powder was about 100-500 nm, and the particle size remained unchanged after the surface modification, but the modified powder had a rougher surface due to the deposition of silicon oxide. FIG. 2 is a TEM (Transmission Electron Microscopy) picture of the modified zinc oxide. The difference in contrast between the core and shell is clearly seen in the picture.

TEM and UV Transmittance Analysis

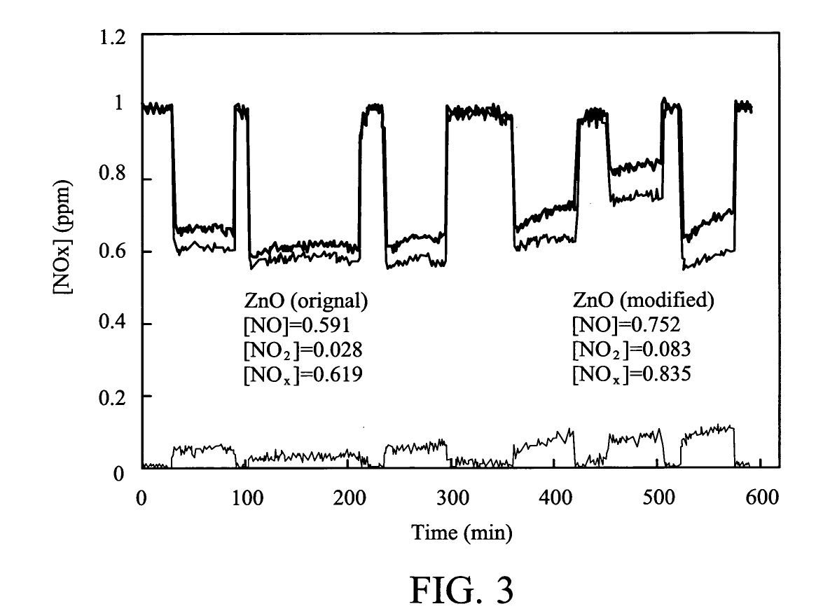

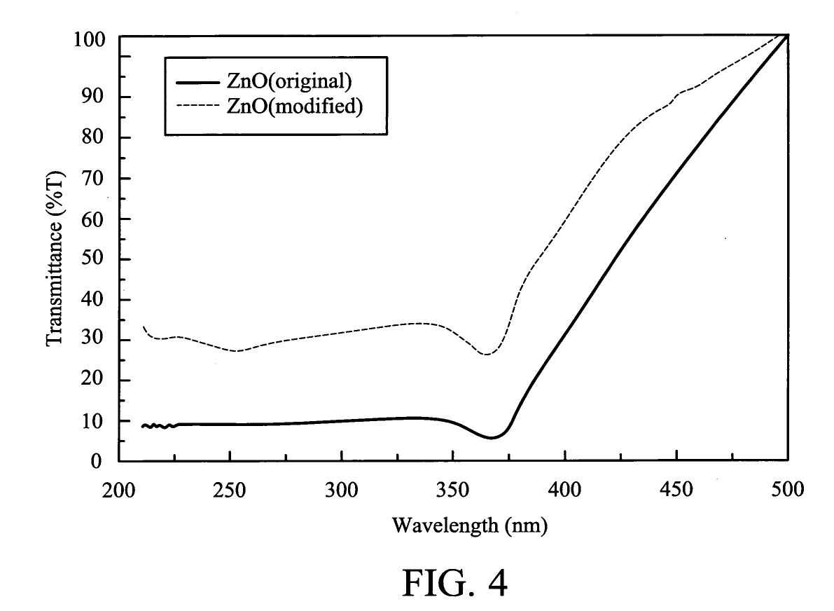

Referring to FIG. 3, the photocatalytic analysis shows that the silicon oxide coating reduced about 80% photocatalytic activity of the original zinc oxide. The content of the silicon oxide coating was determined by eriochrome black T titration of the modified zinc oxide and found to be less than 20% by weight. FIG. 4 is a diagram showing UV transmission curves of the modified and non-modified zinc oxide. As shown, the modified zinc oxide exhibited an ultraviolet transmittance of less than 55% across the entire UV region (230-400 nm). Further, the ultraviolet transmittance was less than 35% in UV-B region (280-315 nm) and UV-C region (230-280 nm).

QUV Test

A dispersion solution containing the modified zinc oxide powder and menhaden oil as dispersant was added to a PU resin, coated on release paper, and dried into a test sample. The test sample was irradiated by 310-320 nm UV light for 7 days in accordance with ASTM G154-00a. Thereafter, the yellowing index of the test sample was determined by ISO Gray Scale 105/A02. The higher the index value, the better the resistance to yellowing effects. The same procedure was repeated on pure PU and test samples containing organic UV absorber, non-modified zinc, and hindered amine, respectively. The test results are summarized in Table 1, wherein the test sample no.1 contained non-modified zinc oxide, no. 2 was pure PU, no. 3 contained the modified zinc oxide, no. 4 contained a commercial benzotriazole-type UV absorber, and no. 5 contained a hinder amine, bis(1,2,2,6,6-pentamethyl-4-piperidyl)sebacate and the modified zinc oxide (weight ratio=2:1).

TABLE 1

| | Sample no. | | | | |
|---|---|---|---|---|---|
| | 1 | 2 | 3 | 4 | 5 |
| Yellowing index | 1.5 | 1.5 | 3.0 | 3.0 | 3.5 |

As shown in Table 1, the sample containing the modified zinc oxide (no. 3) showed improved yellowing resistance over that containing non-modified zinc oxide (no. 1) and pure PU (no. 2). In addition, the sample containing the modified zinc oxide and hindered amine (no. 5) also showed improved yellowing resistance over that containing benzotriazole-type UV absorber.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An ultraviolet absorber formulation, comprising:
a zinc oxide powder and a transparent coating on surfaces of the zinc oxide powder, thereby forming a core-shell structures
a fish oil as dispersant; and
a hindered amine,
wherein the formulation is added in polyurethane to prevent or reducing yellowing.

2. The formulation as claimed in claim 1, wherein the transparent coating constitutes about 10-40% by weight of the core-shell structure.

3. The formulation as claimed in claim 1, wherein the transparent coating reduces at least about 70-80% photocatalytic activity of the zinc oxide powder.

4. The formulation as claimed in claim 1, wherein the transparent coating has a thickness of about 5-100 nm and the zinc oxide powder has a diameter of about 10 nm-5 μm.

5. The formulation as claimed in claim 1, having an ultraviolet transmittance of less than 55% in wavelengths of 230-400 nm.

6. The formulation as claimed in claim 1, having an ultraviolet transmittance of less than 35% in wavelengths of 280-315nm (UV-B region) and 230-280 nm (UV-C region).

7. (canceled)

8. The formulation as claimed in claim 1, wherein the fish oil is menhaden oil.

9. (canceled)

10. The formulation as claimed in claim 1, wherein the hindered amine comprises bis(N-methyl-2,2,6,6-tetramethyl-4-piperidyl) sebacate, methyl-(N-methyl-2,2,6,6-tetramethyl-4-piperidyl) sebacate, bis(2,2,6,6- tetramethyl-4-piperidyl) sebacate, or bis(1,2,2,6,6-pentamethyl-4-piperidyl) sebacate.

11. The formulation as claimed in claim 1, wherein the hindered amine is an organic hindered amine.

12. The formulation as claimed in claim 1, wherein the hindered amine and the zinc oxide powder have a weight ratio of 2.5-1:1.

13-28. (canceled)

29. A polyurethane composition, comprising the ultraviolet absorber formulation of claim 1.
